(19) United States
(12) Patent Application Publication
(10) Pub. No.: US 2025/0210051 A1
(43) Pub. Date: Jun. 26, 2025

(54) ENCODER AND ENCODING METHOD FOR DISCONTINUOUS TRANSMISSION OF PARAMETRICALLY CODED INDEPENDENT STREAMS WITH METADATA

(71) Applicant: Fraunhofer-Gesellschaft zur Förderung der angewandten Forschung e.V., München (DE)

(72) Inventors: Srikanth KORSE, Erlangen (DE); Stefan BAYER, Erlangen (DE); Markus MULTRUS, Erlangen (DE); Guillaume FUCHS, Erlangen (DE); Andrea EICHENSEER, Erlangen (DE); Kacper SAGNOWSKI, Erlangen (DE); Stefan DÖHLA, Erlangen (DE); Jan Frederik KIENE, Erlangen (DE)

(73) Assignee: Fraunhofer-Gesellschaft zur Förderung der angewandten Forschung e.V., München (DE)

(21) Appl. No.: 19/074,413

(22) Filed: Mar. 9, 2025

Related U.S. Application Data
(63) Continuation of application No. PCT/EP2023/074552, filed on Sep. 7, 2023.

(30) Foreign Application Priority Data
Sep. 9, 2022 (WO) PCT/EP2022/075144

(51) Int. Cl. G10L 19/008; G10L 19/018; G10L 19/032; G10L 25/78

(52) U.S. Cl. CPC G10L 19/008; G10L 19/018; G10L 19/032; G10L 25/78

(57) ABSTRACT

An audio encoder according to an embodiment is provided. The audio encoder comprises a transport signal generator for generating two or more transport channels of a transport signal from audio input comprising at least one of a plurality of audio input objects and a plurality of audio input channels. Moreover, the audio encoder comprises a voice activity determiner for determining a voice activity decision for the transport signal, which indicates whether or not the audio input within the transport signal exhibits voice activity. Furthermore, the audio encoder comprises a bitstream generator for generating a bitstream depending on the audio input.

### CROSS-REFERENCE TO RELATED APPLICATIONS

This application is a continuation of copending International Application No. PCT/EP2023/074552, filed Sep. 7, 2023, which is incorporated herein by reference in its entirety, and additionally claims priority from International Application No. PCT/EP2022/075144, Sep. 9, 2022, which is also incorporated herein by reference in its entirety.

The present invention relates to audio scenes with Independent Streams with Metadata (ISM) that are parametrically coded, to a discontinuous transmission (DTX) mode and comfort noise generation (CNG) for audio scenes with independent streams with metadata (ISM) that are parametrically coded, to immersive voice and audio services (IVAS). In particular, the present invention relates to coders and methods for discontinuous transmission of parametrically coded independent streams with metadata (DTX for Param-ISMs).

### BACKGROUND OF THE INVENTION

In the IVAS codec, at low bitrates, audio objects or independent streams with metadata are coded in a parametric fashion. In the first step, a downmix (e.g., a stereo downmix, or virtual cardioids) and metadata may, e.g., be computed from the audio objects and from quantized direction information (for example, from azimuth and elevation). The downmix is then encoded, e.g., to obtain one or more transport channels, and may, e.g., be transmitted to the decoder along with metadata. The metadata may, e.g., comprise direction information (e.g., azimuth and elevation), power ratios and object indices corresponding to dominant objects which are subset of input objects. At the decoder, a covariance renderer may, e.g., receive the transmitted metadata along with the stereo downmix/transport channels as input and may, e.g., render it to needed loudspeaker layout (see [1], [2]).

Usually, in a communication codec, Discontinuous Transmission (DTX) is employed to drastically reduce the transmission rate in the absence of voice input. In this mode, the frames are first classified into “active” frames (i.e. frames containing speech) and “inactive” frames (i.e. frames containing either background noise or silence). Later, for inactive frames, the codec runs in DTX mode to drastically reduce the transmission rate. Most frames that are determined to comprise background noise are dropped from transmission and are replaced by some Comfort Noise Generation (CNG) at the decoder. For these frames, a very low-rate parametric representation of the signal is transmitted using Silence Insertion Descriptor (SID) frames sent regularly but not at every frame. This allows the CNG in the decoder to produce an artificial noise resembling the actual background noise.

A concept employed according to conventional technology is Discontinuous Transmission (DTX). Comfort noise generators are usually used in Discontinuous Transmission of speech. According to this concept, the speech is first classified into active and inactive frames by a Voice Activity Detector (VAD). An example of a VAD can be found in [3]. Based on the VAD result, only the active speech frames are coded and transmitted at the nominal bit-rate. During long pauses, where only the background noise or silence is present, the bit-rate is lowered or zeroed, and the background noise/silence is coded episodically and parametrically. The average bit-rate is thus significantly reduced. The noise is generated during the inactive frames at the decoder side by a Comfort Noise Generator (CNG). For example the speech coders AMR-WB [3] and 3GPP EVS [4], [5] both have the possibility to be run in DTX mode. An example of an efficient CNG is given in [6]. In the IVAS codec, a discontinuous transmission (DTX) system exists for audio scenes that are parametrically coded by the directional audio coding (DirAC) paradigm or transmitted in Metadata-Assisted Spatial Audio (MASA) format (see [7]).

In discrete independent streams with metadata (discrete-ISM), the encoder of discrete ISM accepts the audio objects and its associated metadata. The objects are then individually encoded along with the metadata which comprises object direction information, e.g., azimuth and elevation, on a frame basis and the encoding is then transmitted to the decoder. The decoder then decodes the individual objects independently and renders them to a specified output layout by applying amplitude panning techniques using quantized direction information.

Another concept of conventional technology are parametrically coded independent streams with metadata (Param-ISM). FIG. 4 illustrates an overview of a corresponding encoder, wherein, inter alia, the encoded audio signal 491 and the encoded parametric side information 495, 496, 497 are depicted.

The encoder of parametric ISM (Param-ISM) receives audio objects and associated metadata as input. The metadata may, e.g., comprise an object direction (e.g., an azimuth with, e.g., values between [−180, 180] and, e.g., an elevation with, e.g., values between [−90, 90]) on a frame basis, which is then quantized and used during the computation of the stereo downmix (e.g., virtual cardioids, or the transport channels). In addition, among the input audio objects, two dominant objects and a power ratio among the two dominant objects may, e.g., be determined per time/frequency tile. The metadata may, e.g., then be quantized and encoded along with the object indices of the two dominant objects the two dominant objects per time/frequency tile.

The encoded bitstream 490 may, e.g., comprise stereo downmix/transport channels 491 which are individually encoded with the help of the core coder, encoded dominant object indices 495, power ratios 496, which are quantized and encoded, and direction information 497, e.g., azimuth and elevation, which are quantized and encoded.

FIG. 5 illustrates a simplified overview of a decoder. The decoder receives the bitstream 490 and obtains the encoded stereo downmix/transport channels 491, the encoded object indices 495, the encoded power ratios 496 and the encoded direction information 497. The encoded stereo downmix/transport channels 491, are then decoded using a core decoder and transformed into a time/frequency representation using an analysis filterbank, e.g. a Complex Low Delay Filterbank (CLDFB). The decoded object indices may e.g. be used along with decoded and dequantized direction information, e.g., azimuth and elevation and output configuration e.g., 5.1, 5.1+4, 7.1, 7.1+4, etc., to compute the direction response. The direct response may e.g., along with transport channels/stereo downmix in time/frequency representation, the prototype matrix and decoded and dequantized power ratios is provided as input to the covariance synthesis which operate in time/frequency domain. The output of covariance synthesis is converted from time/frequency representation to time domain representation using a synthesis filter e.g. CLDFB.

FIG. 6 illustrates a detailed overview of the covariance synthesis step, without reflecting dimensions of input/output data.

The covariance synthesis computes the mixing matrix (M) per time/frequency tile that renders the input transport channel(s)

$$( x = x ( k , n ) = {[ {X}_{1} ( k , n ) , {X}_{2} ( k , n ) ]}^{T} )$$

to the desired output loudspeaker layout

$$( y = y ( k , n ) = {[ {Y}_{1} ( k , n ) , {Y}_{2} ( k , n ) , {Y}_{3} ( k , n ) , … ]}^{T} )$$

(for example a 5.1 loudspeaker layout, a 7.1 loudspeaker layout, a 7.1+4 loudspeaker layout, etc.):

$$y = Mx$$

For the mixing matrix, the covariance synthesis may employ the prototype matrix, the input covariance matrix Cₓ=xx^{T} and the target covariance matrix C_{Y}. The target covariance matrix is computed with the help of signal power computed from the transport channels/stereo downmix, power ratios and direct response.

### SUMMARY

According to an embodiment, an audio encoder may have: a transport signal generator for generating two or more transport channels of a transport signal from audio input comprising at least one of a plurality of audio input objects and a plurality of audio input channels, a voice activity determiner for determining a voice activity decision for the transport signal, which indicates whether or not the audio input within the transport signal exhibits voice activity, and a bitstream generator for generating a bitstream depending on the audio input, wherein, if the voice activity determiner has determined that the transport signal exhibits voice activity, the bitstream generator is adapted to encode the two or more transport channels within the bitstream, wherein, if the voice activity determiner has determined that the transport signal does not exhibit voice activity, the bitstream generator is suitable to encode, instead of the two or more transport channels, information on a background noise, wherein the information on the background noise comprises information on a background noise of at least one of the two or more transport channels or information on a background noise of a derived signal which depends on at least one of the two or more transport channels.

According to another embodiment, a system may have: an inventive audio encoder, and an audio decoder, wherein the audio decoder may have: an input interface for receiving a bitstream which depends on audio content comprising at least one of a plurality of audio objects and a plurality of audio channels; wherein a transport signal comprising two or more transport channels is encoded within the bitstream, and the audio content is encoded within the transport signal; or wherein information on a background noise is encoded within the bitstream instead of the transport signal, wherein the information on the background noise comprises information on a background noise of at least one of the two or more transport channels or information on a background noise of a derived signal which depends on at least one of the two or more transport channels; and a renderer for generating one or more audio output signals depending on the audio content being encoded with the bitstream; wherein, if the transport signal comprising the two or more transport channels is encoded within the bitstream, the renderer is configured to generate the one or more audio output signals depending on the two or more transport channels, and wherein, if the information on the background noise is encoded within the bitstream instead of the transport signal, the renderer is configured to generate the one or more audio output signals depending on the information on the background noise, wherein the audio encoder is configured to generate a bitstream from audio input, and wherein the audio decoder is configured to generate one or more audio output signals from the bitstream.

According to another embodiment, a method for audio encoding may have the steps of: generating two or more transport channels of a transport signal from audio input comprising at least one of a plurality of audio input objects and a plurality of audio input channels, determining a voice activity decision for the transport signal, which indicates whether or not the audio input within the transport signal exhibits voice activity, and determining a bitstream depending on the audio input, wherein, if it has been determined that the transport signal exhibits voice activity, the method comprises encoding the two or more transport channels within the bitstream, wherein, if it has been determined that the transport signal does not exhibit voice activity, the method comprises encoding, instead of the two or more transport channels, information on a background noise of at least one of the two or more transport channels or information on a background noise of a derived signal which depends on at least one of the two or more transport channels.

Another embodiment may have a non-transitory digital storage medium having a computer program stored thereon to perform the inventive method for audio encoding when said computer program is run by a computer.

An audio encoder according to an embodiment is provided. The audio encoder comprises a transport signal generator for generating two or more transport channels of a transport signal from audio input comprising at least one of a plurality of audio input objects and a plurality of audio input channels. Moreover, the audio encoder comprises a voice activity determiner for determining a voice activity decision for the transport signal, which indicates whether or not the audio input within the transport signal exhibits voice activity. Furthermore, the audio encoder comprises a bitstream generator for generating a bitstream depending on the audio input. If the voice activity determiner has determined that the transport signal exhibits voice activity, the bitstream generator is adapted to encode the two or more transport channels within the bitstream. If the voice activity determiner has determined that the transport signal does not exhibit voice activity, the bitstream generator is suitable to encode, instead of the two or more transport channels, information on a background noise, wherein the information on the background noise comprises information on a background noise of at least one of the two or more transport channels or information on a background noise of a derived signal which depends on at least one of the two or more transport channels.

For example, according to an embodiment, the number of transport channels is less than or equal to the number of input channels.

Moreover, a method for audio encoding according to an embodiment is provided. The method comprises:
Generating two or more transport channels of a transport signal from audio input comprising at least one of a plurality of audio input objects and a plurality of audio input channels.
Determining a voice activity decision for the transport signal, which indicates whether or not the audio input within the transport signal exhibits voice activity. And:
Determining a bitstream depending on the audio input.

If it has been determined that the transport signal exhibits voice activity, the method comprises encoding the two or more transport channels within the bitstream. If it has been determined that the transport signal does not exhibit voice activity, the method comprises encoding, instead of the two or more transport channels, information on a background noise of at least one of the two or more transport channels or information on a background noise of a derived signal which depends on at least one of the two or more transport channels.

Moreover, a computer program for implementing the above-described method when being executed on a computer or signal processor is provided.

Furthermore, an audio decoder according to an embodiment is provided. The audio decoder comprises an input interface for receiving a bitstream which depends on audio content comprising at least one of a plurality of audio objects and a plurality of audio channels. A transport signal comprising two or more transport channels is encoded within the bitstream, and the audio content is encoded within the transport signal. Or, information on a background noise is encoded within the bitstream instead of the transport signal, and the information on the background noise comprises information on a background noise of at least one of the two or more transport channels or information on a background noise of a derived signal which depends on at least one of the two or more transport channels. Furthermore, the audio decoder comprises a renderer for generating one or more audio output signals depending on the audio content being encoded with the bitstream. If the transport signal comprising the two or more transport channels is encoded within the bitstream, the renderer is configured to generate the one or more audio output signals depending on the two or more transport channels. If the information on the background noise is encoded within the bitstream instead of the transport signal, the renderer is configured to generate the one or more audio output signals depending on the information on the background noise.

Moreover, a method for audio decoding is provided. The method comprises:
Receiving a bitstream which depends on audio content comprising at least one of a plurality of audio objects and a plurality of audio channels. A transport signal comprising two or more transport channels is encoded within the bitstream. The audio content is encoded within the transport signal. Or, information on a background noise is encoded within the bitstream instead of the transport signal, and the information on the background noise comprises information on a background noise of at least one of the two or more transport channels or information on a background noise of a derived signal which depends on at least one of the two or more transport channels. And:
Generating one or more audio output signals depending on the audio content being encoded with the bitstream.

If the transport signal comprising the two or more transport channels is encoded within the bitstream, generating the one or more audio output signals is conducted depending on the two or more transport channels. If the information on the background noise is encoded within the bitstream instead of the transport signal, generating the one or more audio output signals is conducted depending on the information on the background noise.

Furthermore, a computer program for implementing the above-described method when being executed on a computer or signal processor is provided.

Some embodiments are based on the finding that by combining existing solutions, one may, for example, apply DTX independently on individual streams, e.g., on audio objects or on individual channels, for example, of a stereo downmix/transport channels. This, however, would be incompatible with DTX, which is designed for low bit-rate communication, since, for more than one object or for transport channels or for a downmix with more than one channel, the available number of bits would be insufficient to describe the inactive parts of the input signal efficiently. In addition, such an approach would also face problems due to individual VAD decisions being not in synchronization. Spatial artefacts would result.

In embodiments, a DTX system for audio scenes described by (audio) objects and its associated metadata is provided.

Some embodiments provide a DTX system and especially a SID and CNG for audio objects (aka ISMs i.e. Independent Streams with Metadata) which are coded parametrically (e.g., as Param-ISMs).

In some embodiments, a drastic reduction of the bit-rate demand for transmitting conversational immersive speech is achieved.

According to some embodiments, DTX concepts are provided, which are extended to immersive speech with spatial cues.

In some embodiments, the two most dominant objects per time/frequency unit are considered. In other embodiments, more than two most dominant objects per time/frequency unit are considered, especially for an increasing number of input objects. For readability of the text, the embodiments in the following are mostly described with respect to two dominant objects per time/frequency unit, but these embodiments may, e.g., be extended in other embodiments to more than two dominant objects per time/frequency unit, analogously.

Particular embodiments of an audio encoder are provided.

According to an embodiment, an audio encoder for encoding a plurality of (audio) objects and its associated metadata is provided.

The audio encoder may, e.g., comprise a direction information determiner for extracting direction information and a direction information quantizer for quantizing the direction information.

Moreover, the audio encoder may, e.g., comprise a transport signal generator (downmixer) for generating a transport signal (downmix) comprising at least two transport channels (e.g., downmix channels) from the input audio objects and from the quantized direction information, for example, azimuth and elevation, that are associated with the input audio objects.

Furthermore, the audio encoder may, e.g., comprise a decision logic module for combining individual VAD decisions of transport channels to compute an overall decision on whether the frame is active or not.

Moreover, the audio encoder may, e.g., comprise a mono signal generator (e.g., a stereo to mono converter) for outputting a mono signal from the transport channels to be encoded in the inactive phase.

Furthermore, the audio encoder may, e.g., comprise an inactive metadata generator for generating (e.g., computing) inactive metadata to be transmitted during inactive phase.

Moreover, the audio encoder may, e.g., comprise an active metadata generator for generating (e.g., computing) active metadata to be transmitted during active phase.

Furthermore, the audio encoder may, e.g., comprise a transport channel encoder configured to generate encoded data by encoding the dowmixed signal which comprises the transport channels in an active phase.

Moreover, the audio encoder may, e.g., comprise a transport channel silence insertion description generator for generating a silence insertion description of the background noise of a mono signal in an inactive phase.

Furthermore, the audio encoder may, e.g., comprise a multiplexer for combining the active metadata and the encoded data into a bitstream during active phases, and for sending either no data or for sending the silence insertion description. Or, the multiplexer may, e.g., be configured for combining sending the silence insertion description and the inactive metadata during inactive phases.

According to an embodiment, the transport signal generator/the downmixer may, e.g., apply the CELP coding scheme CELP=Code-Excited Linear Prediction), or may, e.g., apply a MDCT-based coding scheme (MDCT=Modified Discrete Cosine Transform), or may, e.g., apply a switched combination of the two coding schemes.

In an embodiment, the active phases and inactive phases may, e.g., be determined by first running a voice activity detector individually on the transport/downmix channels and by later combining the results for the transport/downmix channels to determine the overall decision.

According to an embodiment, a mono signal may, e.g., be computed from the transport/downmix channels, for example, by adding the transport channels, or, for example, by choosing the channel with a higher long term energy.

In an embodiment, the active and inactive metadata may, e.g., differ in a quantization resolution, or in a type (a nature) of (employed) parameters.

According to an embodiment, the quantization resolution of the direction information transmitted and the one used to compute the downmix may, e.g., be different in an inactive phase.

In an embodiment, the spatial audio input format may, e.g., described by objects and its associated metadata (e.g., by Independent Streams with Metadata).

According to an embodiment, two or more transport channels may, e.g., be generated.

Moreover, particular embodiments of an audio decoder are provided.

According to embodiment, an audio decoder for (decoding and) generating a spatial audio output signal from a bitstream. The bitstream may, e.g., exhibit at least an active phase followed by at least an inactive phase. Moreover, the bitstream may, e.g., have encoded therein at least a silence insertion descriptor frame (SID), which may, e.g., describe a background noise characteristics of transport/downmix channels and/or of spatial image information

The audio decoder may, e.g., comprise an SID decoder (silence insertion descriptor decoder), which may, e.g., be configured to decode a silence insertion descriptor frame of a mono signal.

Moreover, the audio decoder may, e.g., comprise a mono to stereo converter, which may, e.g., be configured to generate, during an inactive phase/mode, at least two (downmix) channels from the SID information of a mono signal and from control parameters, which may, e.g., describe the characteristics of stereo downmix/transport channels, e.g., a scaling parameter, and/or, e.g., either a broadband coherence or a broadband correlation, computed from stereo downmix/transport channels at the encoder side.

Furthermore, the audio decoder may, e.g., comprise a transport channel decoder, which may, e.g., be configured to reconstruct, during an active phase/mode, the transport/downmix channels from the bitstream during the active phase.

Moreover, the audio decoder may, e.g., comprise a (spatial) renderer, which may, e.g., be configured to reconstruct, during the active phase/mode, a spatial output signal from the decoded transport/downmix channels and, e.g., from the transmitted active metadata and, e.g., from the reconstructed background noise in the transport/downmix channels and, e.g., from transmitted inactive metadata during the inactive phase.

According to an embodiment, the mono to stereo converter may, e.g., comprise a random generator, which may, e.g., be executed at least twice with a different seed for generating noise, and the generated noise may, e.g., be processed using decoded SID information of the mono signal and using control parameters which may, e.g., describe the characteristics of stereo downmix/transport channels, e.g., a scaling parameter, and/or, e.g., either a broadband coherence or a broadband correlation, computed from stereo downmix/transport channels at the encoder side.

In an embodiment, the spatial parameters transmitted in the active phase may, e.g., comprise objects indices, power ratios, which may, for example, be transmitted in frequency sub-bands, and direction information (e.g., azimuth and elevation), which may, e.g., be transmitted broad-band.

According to an embodiment, the spatial parameters transmitted in the inactive phase may, e.g., comprise direction information (e.g., azimuth and elevation) which may, e.g., be transmitted broad-band, and control parameters which may, e.g., describe the characteristics of stereo downmix/transport channels, e.g., a scaling parameter, and/or, e.g., either a broadband coherence or a broadband correlation, computed from stereo downmix/transport channels at the encoder side.

In an embodiment, the quantization resolution of the direction information in the inactive phase differs from the quantization resolution of the direction information in the active phase.

According to an embodiment, the transmission of control parameters may, e.g., either be conducted in broadband or may, e.g., be conducted in frequency sub-bands, wherein a decision, whether to conduct in broadband or in frequency sub-bands may, e.g., be determined depending on a bitrate availability.

In an embodiment, the renderer may, e.g., be configured to conduct covariance synthesis.

The renderer may, e.g., comprise a signal power computation unit for computing a reference power depending on the transport/downmix channels per time/frequency tile.

Moreover, the renderer may, e.g., comprise a direct power computation unit for scaling the reference power using transmitted power ratios in the active phase, and using a constant scaling factor in inactive phase.

Furthermore, the renderer may, e.g., comprise direct response computation unit for computing a direct response depending on quantized direction information of dominant objects during the active phase or depending on quantized direction information of all transmitted objects during the inactive phase.

Moreover, the renderer may, e.g., comprise an input covariance matrix computation unit for computing the input covariance matrix based on the transport/downmix channels.

Furthermore, the renderer may, e.g., comprise a target covariance matrix computation unit for computing a target covariance matrix based on the output of direct response computation block and direct power computation block.

Moreover, the renderer may, e.g., comprise a mixing matrix computation unit for computing the mixing matrix for rendering depending on the input covariance matrix and depending on the target covariance matrix.

According to an embodiment, the constant scaling factor used during the inactive phase may, e.g., be determined depending on a transmitted number of objects; or a control parameter may, e.g., be employed.

In an embodiment, the dominant objects may, e.g., be a subset of all transmitted objects, and the number of dominant objects may, e.g., be less than/smaller than a transmitted number of objects.

According to an embodiment, the transport channel decoder may, e.g., comprise a speech decoder, e.g., a CELP based speech decoder, and/or may, e.g., comprise a generic audio decoder, e.g., a TCX based decoder, and/or may, e.g., comprise a bandwidth extension module.

### BRIEF DESCRIPTION OF THE DRAWINGS

Embodiments of the present invention will be detailed subsequently referring to the appended drawings, in which:

FIG. 1 illustrates an audio encoder according to an embodiment.

FIG. 2 illustrates an audio decoder according to an embodiment.

FIG. 3 illustrates a system according to an embodiment.

FIG. 4 illustrates an overview of a Param-ISM encoder.

FIG. 5 illustrates an overview of a Param-ISM decoder.

FIG. 6 illustrates a detailed overview of the covariance synthesis step in Param-ISM, without reflecting dimensions of input/output data.

FIG. 7 illustrates a block diagram according to an embodiment for determining whether a frame is active or inactive.

FIG. 8 illustrates a block diagram of the encoder according to an embodiment.

FIG. 9 illustrates a block diagram of a decoder according to an embodiment.

FIG. 10 illustrates a spatial renderer according to an embodiment.

FIG. 11 illustrates the generation of a stereo signal according to an embodiment, using three random seeds seed1, seed2 and seed3, derived scaling factors, and control parameters.

FIG. 12 illustrates the generation of a stereo signal according to another embodiment, wherein the generated noise N₃(k, n) from the third random generator for the left channel is also used for generating the right channel.

### DETAILED DESCRIPTION OF THE INVENTION

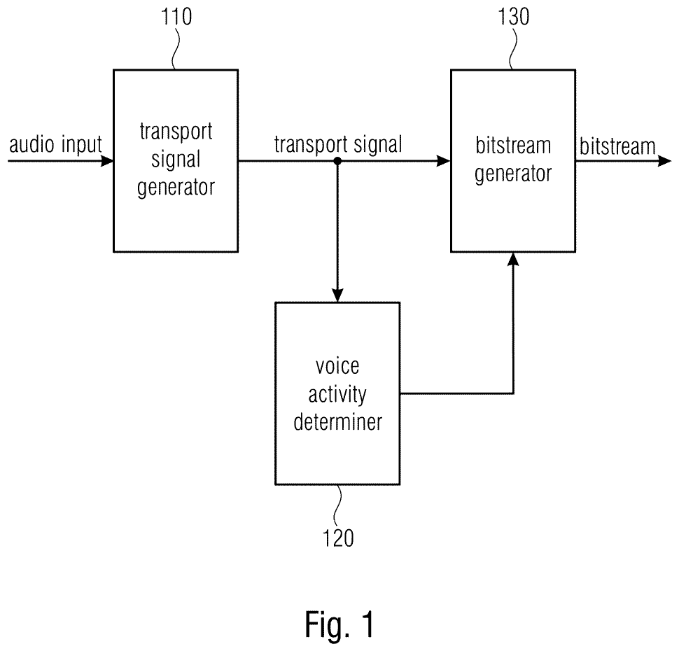

FIG. 1 illustrates an audio encoder 100 according to an embodiment.

The audio encoder 100 comprises a transport signal generator 110 for generating two or more transport channels of a transport signal from audio input comprising at least one of a plurality of audio input objects and a plurality of audio input channels.

Moreover, the audio encoder 100 comprises a voice activity determiner 120 for determining a voice activity decision for the transport signal, which indicates whether or not the audio input within the transport signal exhibits voice activity.

Furthermore, the audio encoder 100 comprises a bitstream generator 130 for generating a bitstream depending on the audio input.

If the voice activity determiner 120 has determined that the transport signal exhibits voice activity, the bitstream generator 130 is adapted to encode the two or more transport channels within the bitstream.

If the voice activity determiner 120 has determined that the transport signal does not exhibit voice activity, the bitstream generator 130 is suitable to encode, instead of the two or more transport channels, information on a background noise, wherein the information on the background noise comprises information on a background noise of at least one of the two or more transport channels or information on a background noise of a derived signal which depends on at least one of the two or more transport channels.

According to an embodiment, the voice activity determiner 120 may, e.g., be configured to determine an individual voice activity decision for each transport channel of one or more transport channels of the transport signal, which indicates whether or not the audio input within the transport channel exhibits voice activity. Moreover, the voice activity determiner 120 may, e.g., be configured to determine the voice activity decision for the transport signal depending on the individual voice activity decision of each transport channel of the one or more transport channels.

In an embodiment, the voice activity determiner 120 may, e.g., be configured to determine an individual voice activity decision for each transport channel of the two or more transport channels of the transport signal, which indicates whether or not the audio input within said transport channel exhibits voice activity. Furthermore, the voice activity determiner 120 may, e.g., be configured to determine the voice activity decision for the transport signal depending on the individual voice activity decision of each transport channel of the two or more one transport channels of the transport signal.

According to an embodiment, the voice activity determiner 120 may, e.g., be configured to determine that the transport signal exhibits voice activity, if at least one of the two or more transport channels of the transport signal exhibits voice activity. Moreover, the voice activity determiner 120 may, e.g., be configured to determine that the transport signal does not exhibit voice activity, if none of the two or more transport channels of the transport signal exhibits voice activity.

In an embodiment, the audio encoder 100 may, e.g., be configured to determine, if the voice activity determiner 120 has determined that the transport signal does not exhibit voice activity, whether to transmit the bitstream having encoded therein the information on the background noise, or whether to not generate and to not transmit the bitstream.

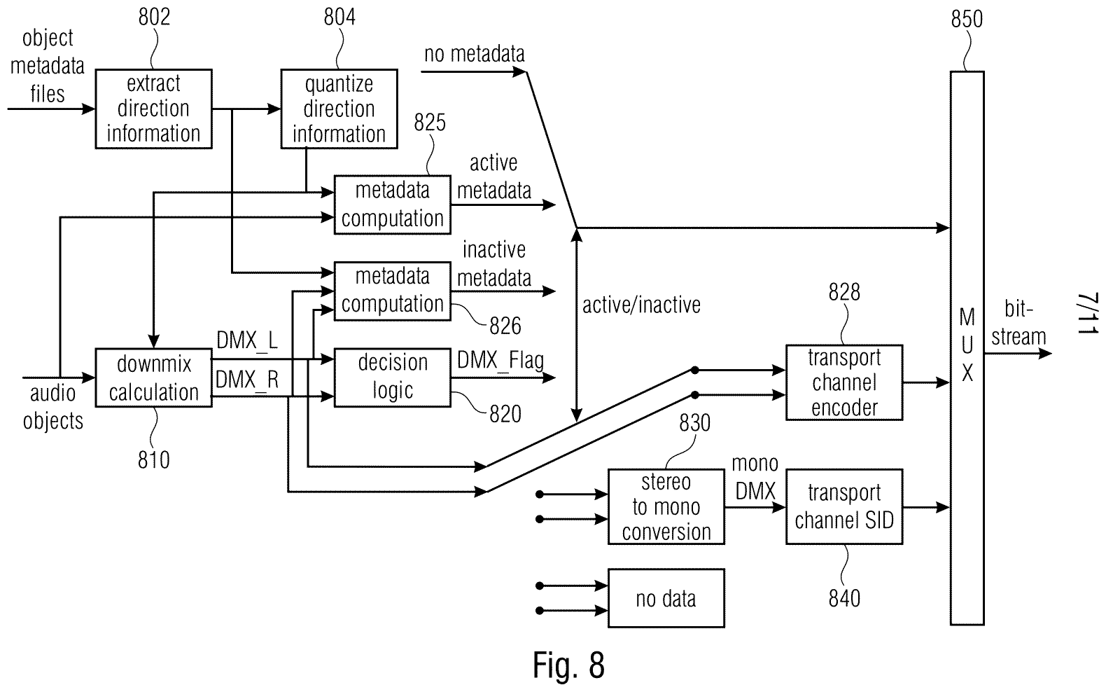

According to an embodiment, the audio encoder 100 may, e.g., comprise a mono signal generator 830 (see FIG. 8) for generating, if the voice activity determiner 120 has determined that the transport signal does not exhibit voice activity, the derived signal as a mono signal from at least one of the two or more transport channels. The audio encoder 100 may, e.g., comprise an information generator for generating the information on the background noise as information on the background noise of the mono signal.

In an embodiment, the mono signal generator 830 may, e.g., be configured to generate the mono signal by adding the two or more transport channels or by adding two or more channels derived from the two or more transport channels. Or, the mono signal generator 830 may, e.g., be configured to generate the mono signal by choosing that transport channel of the two or more transport channels which exhibits a higher energy.

According to an embodiment, the information generator may, e.g., be to configured to generate the information on a background noise of the mono signal as the information on the mono signal.

In an embodiment, the information generator may, e.g., be to configured to generate a silence insertion description of the background noise of the mono signal as the information on the background noise of the mono signal.

According to an embodiment, the audio encoder 100 may, e.g., comprise a direction information determiner 802 (see FIG. 8) for determining direction information depending on the audio input. The audio encoder 100 may, e.g., comprise a direction information quantizer 804 (see FIG. 8) for quantizing the direction information to obtain quantized direction information. The bitstream generator 130 may, e.g., be configured to encode the quantized direction information within the bitstream.

In an embodiment, the transport signal generator 110 may, e.g., be configured to generate the two or more transport channels of the transport signal from the audio input using the direction information.

According to an embodiment, the audio input may, e.g., comprise the plurality of audio input objects. The direction information may, e.g., comprise information on an azimuth angle and on an elevation angle of an audio input object of the plurality of audio input objects of the audio input.

In an embodiment, the audio encoder 100 may, e.g., comprise an active metadata generator 825 (see FIG. 8) for generating metadata comprising at least one of quantized direction information, object indices and power ratios of the plurality of audio input objects and or of the plurality of audio input channels of the audio input, if the voice activity determiner 120 has determined that the transport signal exhibits voice activity.

According to an embodiment, the audio input may, e.g., comprise the plurality of audio input objects. The audio encoder 100 may, e.g., comprise an inactive metadata generator 826 (see FIG. 8) for generating metadata comprising quantized direction information and control parameters, such as, e.g., a scaling factor depending on the number of audio input objects of the plurality of audio input objects of the audio input, or, a scaling factor depending on the long term energy of the transport channels of the transport signal and/or depending on a coherence or a correlation among the transport channels of the transport signal if the voice activity determiner 120 has determined that the transport signal does not exhibit voice activity.

In an embodiment, the quantization resolution of the direction information that may, e.g., be generated by the inactive metadata generator 826 differs in a quantization resolution of the direction information that may, e.g., be generated by the active metadata generator 825.

In an embodiment, the characteristics of the metadata that may, e.g., be generated by the inactive metadata generator 826 differs from the characteristics of the metadata that may, e.g., be generated by the active metadata generator 825.

According to an embodiment, the audio input may, e.g., comprise a plurality of audio input objects and metadata being associated with the audio input objects.

In an embodiment, the transport signal generator 110 may, e.g., be configured to generate the two or more transport channels of the transport signal from the audio input comprising by downmixing at least one of a plurality of audio input objects and a plurality of audio input channels to obtain a downmix as the transport signal, which may, e.g., comprise two or more downmix channels as the two or more transport channels.

According to an embodiment, if the audio input within the transport signal does not exhibit voice activity, the direction information quantizer 804 is configured to determine the quantized direction information such that a quantization resolution of the quantized direction information may, e.g., be different from a quantization resolution used for computing the downmix.

In an embodiment, the bitstream generator 130 may, e.g., be configured to encode control parameters within the bitstream, if the voice activity determiner 120 has determined that the transport signal does not exhibit voice activity. The control parameters may, e.g., be suitable for steering a generation of an intermediate signal from random noise. The control parameters may, e.g., either comprise a plurality of parameter values for a plurality of subbands, or wherein the control parameters may, e.g., comprise a single broadband control parameter.

According to an embodiment, the audio encoder 100 may, e.g., be configured generate the control parameters, by selecting, whether the control parameters either may, e.g., comprise the plurality of parameter values for the plurality of subbands, or whether the control parameters may, e.g., comprise the single broadband control parameters, depending on an available bitrate.

In an embodiment, the transport signal generator 110 may, e.g., be configured to encode the audio input by applying Code-Excited Linear Prediction or by applying a Modified Discrete Cosine Transform or by applying a combination of the Code-Excited Linear Prediction and of the Modified Discrete Cosine Transform.

According to an embodiment, if the audio input comprises the plurality of audio input channels, but not the plurality of audio input objects, a number of the two or more transport channels may, e.g., smaller than a number of the plurality of audio input channels. If the audio input comprises the plurality of audio input objects, but not the plurality of audio input channels, the number of the two or more transport channels may, e.g., be smaller than a number of the plurality of audio input objects. If the audio input comprises both the plurality of audio input objects and the plurality of audio input channels, the number of the two or more transport channels may, e.g., be smaller than a sum of the number of the plurality of audio input channels and the number of the plurality of audio input objects.

Or, according to an embodiment, if the audio input comprises the plurality of audio input channels, but not the plurality of audio input objects, a number of the two or more transport channels may, e.g., smaller than or equal to a number of the plurality of audio input channels. If the audio input comprises the plurality of audio input objects, but not the plurality of audio input channels, the number of the two or more transport channels may, e.g., be smaller than or equal to a number of the plurality of audio input objects. If the audio input comprises both the plurality of audio input objects and the plurality of audio input channels, the number of the two or more transport channels may, e.g., be smaller than or equal to a sum of the number of the plurality of audio input channels and the number of the plurality of audio input objects.

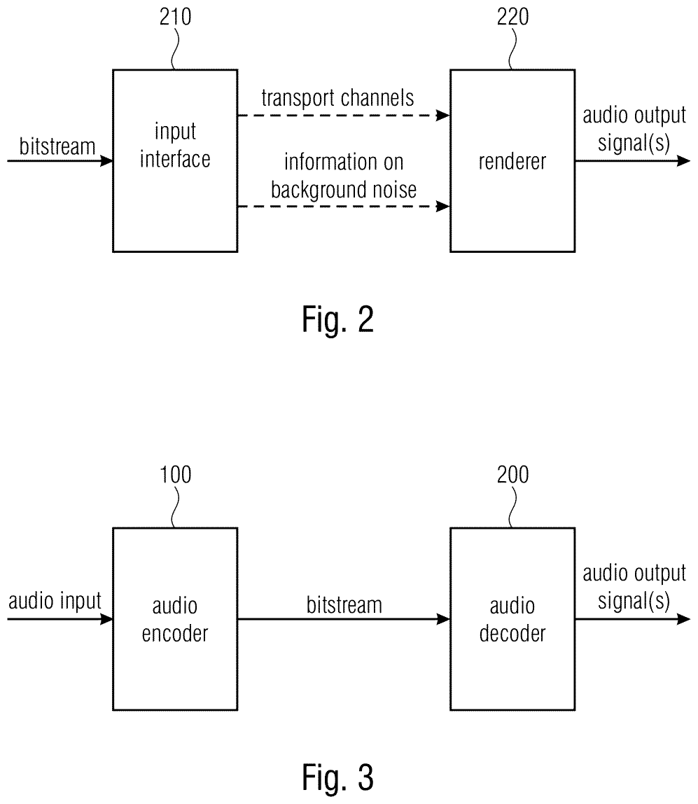

FIG. 2 illustrates an audio decoder 200 according to an embodiment.

The audio decoder 200 comprises an input interface 210 for receiving a bitstream which depends on audio content comprising at least one of a plurality of audio objects and a plurality of audio channels. A transport signal comprising two or more transport channels is encoded within the bitstream, and the audio content is encoded within the transport signal. Or, information on a background noise is encoded within the bitstream instead of the transport signal, and the information on the background noise comprises information on a background noise of at least one of the two or more transport channels or information on a background noise of a derived signal which depends on at least one of the two or more transport channels.

Furthermore, the audio decoder 200 comprises a renderer 220 for generating one or more audio output signals depending on the audio content being encoded with the bitstream;

If the transport signal comprising the two or more transport channels is encoded within the bitstream, the renderer 220 is configured to generate the one or more audio output signals depending on the two or more transport channels.

If the information on the background noise is encoded within the bitstream instead of the transport signal, the renderer 220 is configured to generate the one or more audio output signals depending on the information on the background noise.

According to an embodiment, if the audio content exhibits voice activity, the transport signal comprising the two or more transport channels may, e.g., be encoded within the bitstream. If the audio content does not exhibit voice activity, the information on the background noise may, e.g., be encoded within the bitstream instead of the transport signal.

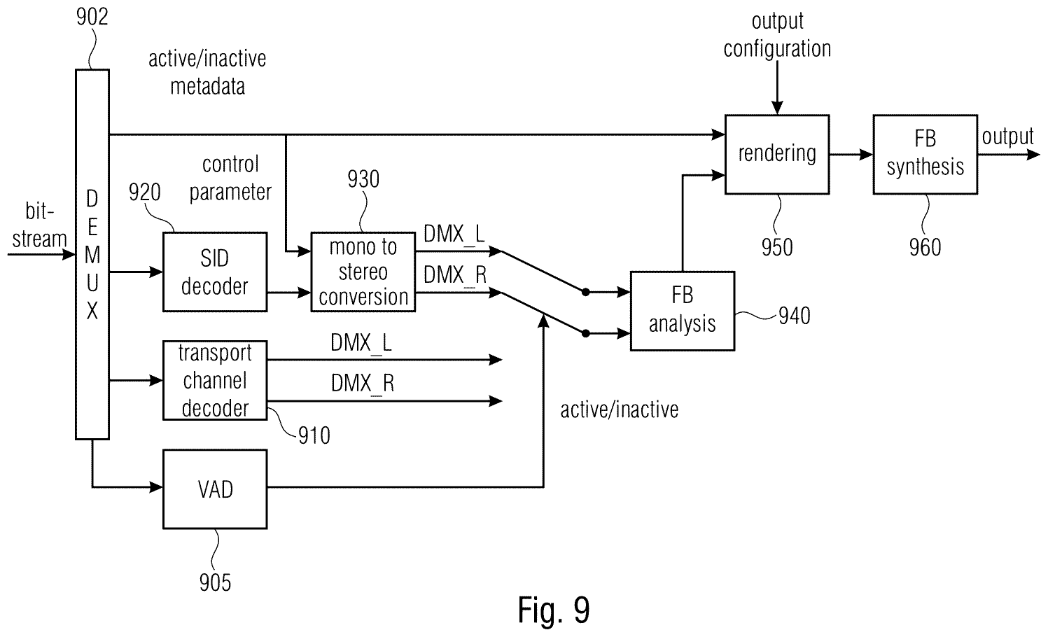

In an embodiment, the audio decoder 200 may, e.g., comprise a demultiplexer 902, a noise information determiner 920 and a multi-channel generator 930 (see FIG. 9). The demultiplexer may, e.g., be configured to determine if the transmitted bitstream corresponds to an active or inactive frame based on the size of the bitstream. If the information on the background noise is encoded within the bitstream, the noise information determiner 920 may, e.g., be configured to determine the information on the background noise from the bitstream, the multi-channel generator 930 may, e.g., be configured to generate the derived signal as an intermediate signal comprising two or more intermediate channels from the information on the background noise, and the renderer 220 may, e.g., be configured to generate the one or more audio output signals depending on the two or more intermediate channels of the intermediate signal.

According to an embodiment, the multi-channel generator 930 may, e.g., comprise a random generator for generating random noise. The multi-channel generator 930 may, e.g., be configured to generate the two or more intermediate channels depending on the random noise.

In an embodiment, the multi-channel generator 930 may, e.g., be configured to shape the random noise depending on the information on the background noise to obtain shaped noise. The multi-channel generator 930 may, e.g., be configured to generate the two or more intermediate channels from the shaped noise.

According to an embodiment, the multi-channel generator 930 may, e.g., be configured to run the random generator at least twice with a different seed to obtain the random noise.

In an embodiment, the multi-channel generator 930 may, e.g., be configured to generate the two or more intermediate channels depending on the random noise and depending on control parameters, e.g., a scaling, and/or, e.g., either a coherence or correlation, which depend on the transport channels of the transport signal, wherein the control parameters may, e.g., be encoded within the bitstream as part of inactive metadata.

According to an embodiment, the control parameters may, e.g., be encoded within the bitstream and may, e.g., comprise a plurality of parameter values for a plurality of subbands, and the multi-channel generator 930 may, e.g., be configured to generate each subband of a plurality of subbands of the two or more intermediate channels depending on a parameter value of the plurality of parameter values of the control parameters being associated with said subband.

In an embodiment, the control parameters may, e.g., be encoded within the bitstream, wherein the control parameters may, e.g., comprise a single broadband control parameter.

According to an embodiment, the multi-channel generator 930 may, e.g., be configured to generate the two or more intermediate channels by generating a first random noise portion of the random noise using the random generator with a first seed, and by generating a first one of the two or more intermediate channels depending on the first random noise portion, by generating a second random noise portion of the random noise using the random generator with a second seed being different from the first seed, and by generating a second one of the two or more intermediate channels depending on the second random noise portion.

According to an embodiment, the multi-channel generator 930 may, e.g., be configured to generate a first one the two or more intermediate channels depending on a first random noise portion and depending on a third noise portion and depending on the control parameters, e.g., a scaling factor and/or, e.g., either a coherence or a correlation. Moreover, the multi-channel generator 930 may, e.g., be configured to generate a second one the two or more intermediate channels depending on a second random noise portion and depending on the third noise portion and depending on the control parameters, e.g., a scaling factor and/or, e.g., either a coherence or a correlation. The multi-channel generator 930 may, e.g., be configured to generate the first random noise portion of the random noise using the random generator with a first seed, to generate the second random noise portion of the random noise using the random generator with a second seed, and to generate the third random noise portion of the random noise using the random generator with a third seed, wherein the second seed is different from the first seed, and wherein the third seed is different from the first seed and different from the second seed.

In an embodiment, the multi-channel generator 930 may, e.g., be configured to generate the two or more intermediate channels by generating by a first one of the two or more intermediate channels depending on the random noise, and by generating a second one of the two or more intermediate channels from the first one of the two or more intermediate channels.

According to an embodiment, the multi-channel generator 930 may, e.g., be configured to generate the second one of the two or more intermediate channels such that the second one of the two or more intermediate channels may, e.g., be identical to the first one of the two or more intermediate channels. Or, the multi-channel generator 930 may, e.g., be configured to generate the second one of the two or more intermediate channels by modifying the first one of the two or more intermediate channels.

In an embodiment, the renderer 220 may, e.g., be configured to generate the two or more audio output signals as the one or more audio output signals.

According to an embodiment, the audio content may, e.g., comprise the plurality of audio objects. If the audio content exhibits voice activity, a plurality of audio object indices being associated with the plurality of audio objects, a plurality of power ratios being associated with the plurality of audio objects for a plurality of subbands and broadband direction information for the plurality of audio objects may, e.g., be encoded within the bitstream, and the renderer 220 may, e.g., be configured to generate the one or more audio output signals depending on the plurality of audio object indices, depending on the plurality of power ratios and depending on the broadband direction information for the plurality of audio objects.

In an embodiment, the audio content may, e.g., comprise the plurality of audio objects. If the audio content does not exhibit voice activity, broadband direction information for the plurality of audio objects and the control parameters may, e.g., be encoded within the bitstream, and the renderer 220 may, e.g., be configured to generate the one or more audio output signals depending on the broadband direction information, and depending on all the object indices and constant power ratios, wherein the constant power ratios depends on the number of transmitted objects.

According to an embodiment, when the audio content exhibits voice activity, a first quantization resolution of the broadband direction information being encoded within the bitstream may, e.g., be different from a second quantization resolution of the broadband direction information, when the audio content does not exhibit voice activity.

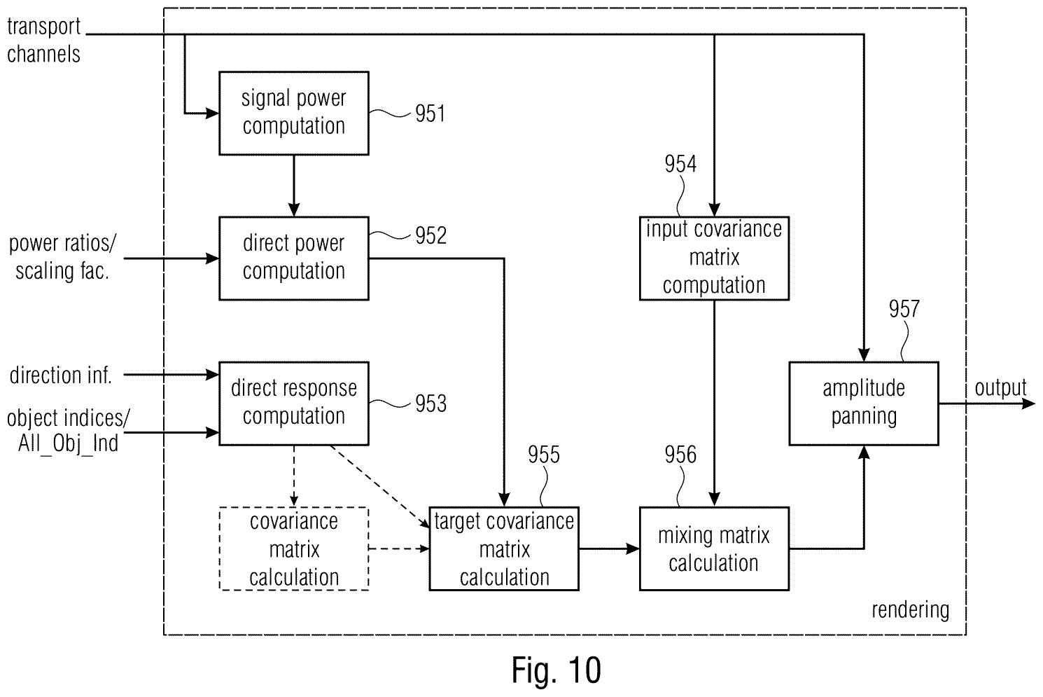

In an embodiment, the renderer 220 may, e.g., comprise a signal power computation unit 951 (see FIG. 10) for computing a reference power depending on the two or more transport channels for each of a plurality of time-frequency tiles. Moreover, the renderer 220 may, e.g., comprise a direct power computation unit 952 (see FIG. 10) for scaling the reference power to obtain a scaled reference power, using transmitted power ratios being encoded within the bitstream, if the audio content exhibits voice activity, and using a scaling factor being encoded within the bitstream, if the audio content does not exhibit voice activity. Furthermore, the renderer 220 may, e.g., be configured to generate the one or more audio output signals depending on the scaled reference power.

According to an embodiment, the renderer 220 may, e.g., comprise a direct response computation unit 953 (see FIG. 10) for computing a direct response, wherein the renderer 220 may, e.g., be configured to compute the direct response depending on quantized direction information of dominant objects being a proper subset of the plurality of audio objects of the audio content, if the audio content exhibits voice activity, wherein the renderer 220 may, e.g., be configured to compute the direct response depending on quantized direction information of all audio objects of the audio content, if the audio content does not exhibit voice activity, wherein the quantized direction information may, e.g., be encoded within the bitstream. The renderer 220 may, e.g., be configured to generate the one or more audio output signals depending on the direct response.

In an embodiment, the renderer 220 may, e.g., comprise an input covariance matrix computation unit 954 (see FIG. 10) for computing an input covariance matrix depending on the two or more transport channels. Moreover, the renderer 220 may, e.g., comprise a target covariance matrix computation unit 955 (see FIG. 10) for computing a target covariance matrix depending on the direct response and depending on the scaled reference power. Furthermore, the renderer 220 may, e.g., comprise a mixing matrix computation unit 956 (see FIG. 10) for computing a mixing matrix for rendering depending on the input covariance matrix and depending on the target covariance matrix. The renderer 220 may, e.g., be configured to generate the one or more audio output signals depending on the mixing matrix.

According to an embodiment, renderer 220 may, e.g., be configured to generate one or more of the transport channels of the transport signal by applying Code-Excited Linear Prediction or by applying a Modified Discrete Cosine Transform or an inverse of the Modified Discrete Cosine Transform or by applying a combination of the Code-Excited Linear Prediction and of the Modified Discrete Cosine Transform.

According to an embodiment, if the audio content comprises the plurality of audio channels, but not the plurality of audio objects, a number of the two or more transport channels may, e.g., smaller than a number of the plurality of audio channels. If the audio content comprises the plurality of audio objects, but not the plurality of audio channels, the number of the two or more transport channels may, e.g., be smaller than a number of the plurality of audio objects. If the audio content comprises both the plurality of audio objects and the plurality of audio channels, the number of the two or more transport channels may, e.g., be smaller than a sum of the number of the plurality of audio channels and the number of the plurality of audio objects.

Or, according to an embodiment, if the audio content comprises the plurality of audio channels, but not the plurality of audio objects, a number of the two or more transport channels may, e.g., smaller than or equal to a number of the plurality of audio channels. If the audio content comprises the plurality of audio objects, but not the plurality of audio channels, the number of the two or more transport channels may, e.g., be smaller than or equal to a number of the plurality of audio objects. If the audio content comprises both the plurality of audio objects and the plurality of audio channels, the number of the two or more transport channels may, e.g., be smaller than or equal to a sum of the number of the plurality of audio channels and the number of the plurality of audio objects.

FIG. 3 illustrates a system according to an embodiment. The system comprises an audio encoder 100 according to one of the above-described embodiments and an audio decoder 200 according to one of the above-described embodiments.

The audio encoder 100 is configured to generate a bitstream from audio input.

The audio decoder 200 is configured to generate one or more audio output signals from the bitstream.

In the following, embodiments are described in detail.

According to an embodiment, (e.g., an encoder of) a DTX system may, e.g., be configured to determine an overall decision if the frame is inactive or active depending on the independent decisions of the channels of the stereo downmix and/or depending on the individual audio objects.

(E.g., the encoder of) the DTX system may, e.g., be configured to transmit a mono signal to the decoder using a Silence Insertion Descriptor (SID) along with inactive metadata.

Moreover, (e.g., a decoder of) the DTX system may, e.g., be configured to generate the transport channels/downmix comprising at least two channels using the comfort noise generator (CNG) from the SID information of just the mono signal.

Furthermore, (e.g., the decoder of) the DTX system may, e.g., be configured to post-process the generated transport channels/downmix with the control parameters where control parameters may, e.g., be computed at the encoder side from the stereo downmix/transport channels.

Moreover, (e.g., the decoder of) the DTX system may, e.g., render the multi-channel transport signal to a defined output layout using modified covariance synthesis.

In the following, further particular embodiments are described.

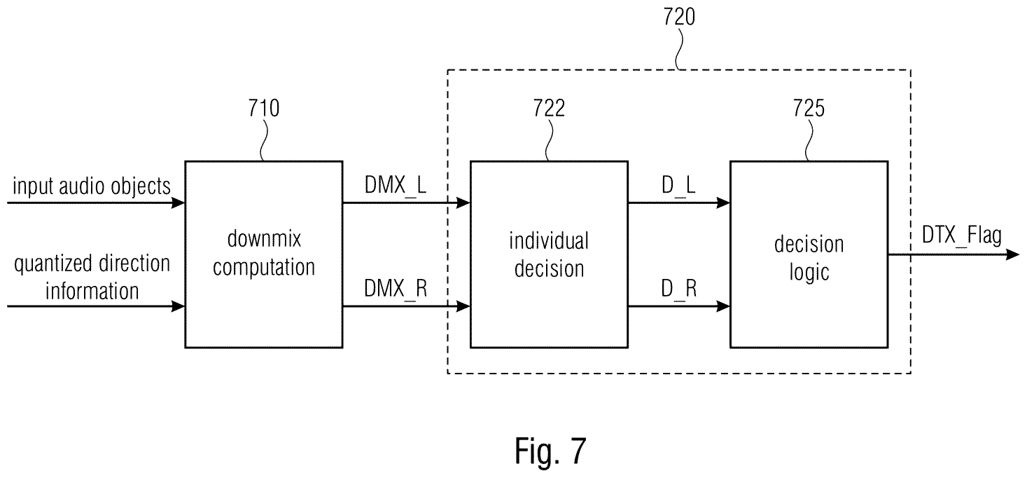

FIG. 7 illustrates a block diagram according to an embodiment for determining whether a frame is active or inactive. The overall decision is based on individual decisions for the transport channels/downmix channels.

In FIG. 7, a transport signal generator (e.g., a downmixer) 710 may, e.g., be configured to receive audio objects and their associated quantized direction information (for example, an azimuth and an elevation).

The transport signal (e.g., downmix (DMX)) for a first transport channel (e.g., a left downmix channel) DMX_{L} and for a second transport channel (e.g., a right downmix channel) DMX_{R} may, e.g., be generated as follows:

$${DMX}_{L} [ k ] = {\sum }_{i = 1}^{N} {w}_{L} [ i ] * x [ i ] [ k ]$$

$${DMX}_{R} [ k ] = {\sum }_{i = 1}^{N} {w}_{R} [ i ] * x [ i ] [ k ]$$

where N is the total number of input objects, k is the sample index and i is the object index

$${w}_{L} [ i ] = 0.5 + 0.5 * cos ( azimuth [ i ] - π / 2 )$$

$${w}_{R} [ i ] = 0.5 + 0.5 * cos ( azimuth [ i ] + π / 2 )$$

In another embodiment, the two transport channels (e.g., downmix channels) may, e.g., be generated, e.g., using a downmix matrix D as follows:

$$( \begin{matrix}{DMX}_{L} \\ {DMX}_{R}\end{matrix} ) = D \cdot ( \begin{matrix}{obj}_{1} \\ ⋮ \\ {obj}_{N}\end{matrix} )$$

wherein obj₁ . . . obj_{N} denotes audio object 1 to audio object N.

Moreover, FIG. 7 depicts a decision logic module 720 which comprises an individual decision logic 722 and an overall decision logic 725.

In FIG. 7, an individual decision logic 722 may, e.g., be configured to decide whether the individual channels are active or inactive. The individual decisions on whether each of the two (or more) transport channels is active or inactive may, e.g., be indicated by an (e.g., internal) flag.

In an embodiment, the individual decision logic 722 may, e.g., be configured to receive the two (or more) transport channels as input. The individual decision logic 722 may, e.g., be configured to determine for each transport channel of the two (or more) transport channels DMX_{L}, DMX_{R} whether or not said transport channel exhibits voice activity or not, e.g., by analyzing said transport channel.

In another embodiment, the individual decision logic 722 may, e.g., analyze all audio input channels or all audio input objects that are used by the transport signal generator 710 to form the two (or more) transport channels DMX_{L}, DMX_{R}. For example, if the individual decision logic 722 detects voice activity in at least one of the audio input channels or audio input objects then the individual decision logic 722 may, e.g., conclude that there is voice activity in the respective transport channel, and may, e.g., conclude that the respective transport channel is active. If, for example, the individual decision logic 722 detects voice activity does not detect voice activity in any of the audio input channels or audio input objects that are used to generate the respective transport channel then the individual decision logic 722 may, e.g., conclude that there is no voice activity in the respective transport channel, and may, e.g., conclude that the respective transport channel is inactive.

Furthermore, in FIG. 7, an overall decision logic 725 may, e.g., be configured to receive the individual decisions (e.g., for the transport channels) as input and may, e.g., be configured to determine the overall decision depending on the individual decisions. For example, the overall decision logic 725 may, e.g., indicate the decision, e.g., using a DTX_FLAG. The overall decision logic may, e.g., determine the overall decision according to the following Table 1, which depicts a frame-wise decision based on frame-wise individual decisions of downmix:

TABLE 1

| Activity in the | | |
|---|---|---|
| first transport | Activity in the second | Overall decision |
| channel (D_L) | transport channel (D_R) | (Decision_Overall) |
| Active | Active | Active |
| Inactive | Active | Active |
| Active | Inactive | Active |
| Inactive | Inactive | Inactive |

The overall decision may, for example, be determined by employing a hysteresis buffer of a predefined size. Using a hysteresis buffer helps to avoid artefacts that can be caused by frequent switching between active and inactive parts. For example, a hysteresis buffer of size 10 may, e.g., need 10 frames before switching from active to inactive decision.

An example pseudo code to determine the overall decision is given below:

Shift the hysteresis buffer by one step, e.g.,

buffer_decision[i]=buffer_decision[i+1]
where i=0, 1, 2 . . . (Buff_size−1)

Buff_decision[buff_size]=Decision_Overall
where Decision_Overall may, e.g., be computed as shown in Table 1.

The overall decision may, e.g., be computed as outlined in the following pseudo code:

DTX_Flag = 1;
for (i=0; i<buff_size; i++)
{
DTX_Flag = DTX_Flag && buffer_decision[i];
}

In the pseudo code, DTX_Flag=1 means “inactive” and DTX_FLAG=0 means “active”.

FIG. 8 illustrates an audio encoder 800 according to an embodiment. The audio encoder of FIG. 8 may, e.g., implement a particular embodiment of the audio encoder 100 of FIG. 1. In particular, FIG. 8 shows the block diagram of the encoder which may, e.g., be configured to receive input audio objects and its associated metadata.

Moreover, the audio encoder 800 may, e.g., comprise a transport signal generator (e.g., a downmixer) 810 (e.g., the transport signal generator 710 of FIG. 7) for generating a downmix (transport channels) comprising at least two channels from the input audio objects and from the quantized direction information, for example, azimuth and elevation, that are associated with the input audio objects.

Furthermore, the audio encoder 800 may, e.g., comprise a voice activity determiner, e.g., being implemented a decision logic module 820 (e.g., decision logic module 720 of FIG. 7) for combining individual VAD decisions of transport channels to compute an overall decision on whether the frame is active or not.

A stereo downmix may, e.g., be computed in the transport signal generator 810 from the input audio objects using quantized direction information (e.g., azimuth and elevation).

The stereo downmix is then fed into the decision logic module 820 where a decision on whether the frame is active or inactive may, e.g., be determined based on the logic described above. For example, the decision logic module 820 may, e.g., comprises an individual decision logic 722 and an overall decision logic 725 as described above.

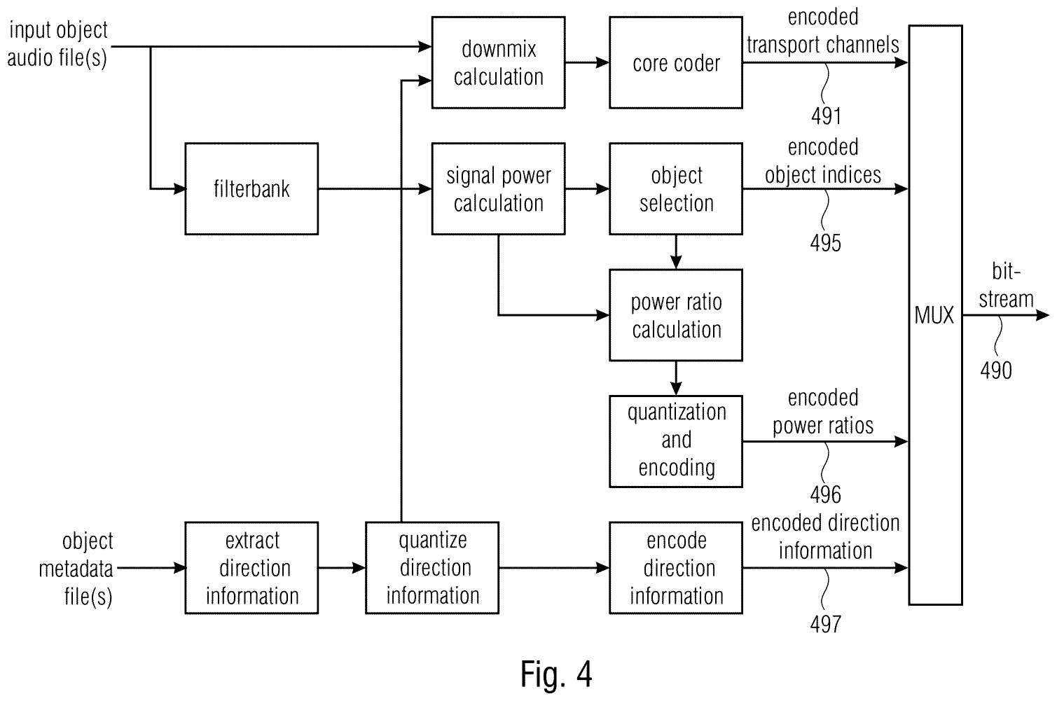

If the decision logic module 820 has determined “active” as the overall decision (for an active frame), the encoder in FIG. 8 provides a more efficient approach compared to the encoder of FIG. 4. For an active downmix, both the channels of the stereo downmix may, e.g., be encoded independently with the transport channel encoder along with the metadata as described in Table 2 (see below).

In contrast, if the decision logic module 820 has determined “inactive” as the overall decision (for an inactive frame), the SID bitrate (e.g. either 4.4 kbps or 5.2 kbps) would be too low for efficient transmission of both channels of the stereo downmix along with the active metadata. Hence, for SID frames, which are transmitted episodically/occasionally, the metadata bitrate may, e.g., be either 1.85 kbps or 2.45 kbps and may, e.g., comprise coarsely quantized direction information (e.g., azimuth and elevation) along with a control parameters that control the spatialness of the background noise and derived from the stereo downmix/transport signal, the control parameters being e.g., a scaling factor and/or, e.g., either a coherence or a correlation.

In embodiments, during inactive frames, no transmission of object indicates and power ratios may, e.g., take place. The main motivation of not transmitting either the object indices or power ratio during inactive frames is the assumption that the background noise does not have any particular direction and is diffused by nature.

Moreover, the audio encoder 800 may, e.g., comprise a transport channel silence insertion description generator 840 for generating a silence insertion description of the background noise of a mono signal in an inactive phase. The transport channel SID generator (transport channel SID encoder) 840 may, for example, operate at 2.4 kbps and may, e.g., receive the mono downmix as input.

Moreover, the audio encoder 800 may, e.g., comprise a mono signal generator (e.g., a stereo to mono converter) 830 for outputting a mono signal from the transport channels to be encoded in the inactive phase. The conversion of stereo downmix to mono downmix may, e.g., be conducted by the mono signal generator (e.g. the stereo to mono converter) 830.

In an embodiment, The downmixing, e.g., stereo to mono conversion may, for example, be implemented as an addition of two stereo transport/downmix channels, for example, as:

$$M = {DMX}_{L} + {DMX}_{R}$$

In another embodiment, the downmixing, e.g., the stereo to mono conversion, may, for example, be implemented as a transmission of just one channel of the stereo downmix. The decision which channel to choose may, e.g., depend on a (e.g., long term) energy of the individual channels of the stereo downmix. For example, the channel with higher long term energy may, e.g., be chosen:

$$M = \{ \begin{matrix}{DMX}_{L} & if {LE}_{L} \geq {LE}_{R} \\ {DMX}_{R} & if {LE}_{R} > {LE}_{L}\end{matrix}$$

where LE_{L} indicates the long term energy of the first (e.g., left) channel and LE_{R} indicates the long term energy of the second (e.g., right) channel.

Table 2 depicts metadata that may, e.g., be transmitted during active and inactive frames:

TABLE 2

| | Metadata |
|---|---|
| Active | Quantized direction information |
| | (e.g., azimuth and elevation) |
| | Object indices indicating the dominant |
| | objects per time/frequency tile |
| | Power ratios among the dominant objects |
| | per time/frequency tile |
| Inactive | Coarsely quantized direction |
| | information (e.g., azimuth and elevation) |
| | Control parameters describing the |
| | spatialness of background noise, |
| | e.g., a scaling factor and/or, e.g., |
| | either a coherence or a correlation, |
| | computed from downmix signal/transport |
| | channels/virtual cardioids |

The audio encoder 800 of FIG. 8 may, e.g., comprise a direction information extractor 802 to extract direction information and a direction information quantizer 804 for quantizing the direction information.

Furthermore, the audio encoder 800 may, e.g., comprise an inactive metadata generator 826 for generating (e.g., computing) inactive metadata to be transmitted during inactive phase.

Moreover, the audio encoder 800 may, e.g., comprise an active metadata generator 825 for generating (e.g., computing) active metadata to be transmitted during active phase.

Furthermore, the audio encoder 800 may, e.g., comprise a transport channel encoder 828 configured to generate encoded data by encoding the dowmixed signal which comprises the transport channels in an active phase.

Furthermore, the audio encoder 800 may, e.g., comprise a bitstream generator, which may, e.g., be implemented as a multiplexer 850 for combining (e.g., an encoding of) the active metadata and the encoded data (e.g., the two or more transport channels) into a bitstream during active phases, and for sending either no data or for sending the silence insertion description. Or, the multiplexer 850 may, e.g., be configured for combining sending the silence insertion description and the inactive metadata during inactive phases.

FIG. 9 illustrates an audio decoder 900 according to an embodiment. The audio decoder 900 of FIG. 9 may, e.g., implement a particular embodiment of the audio decoder 200 of FIG. 2.

The audio decoder 900 may, e.g., receive a bitstream by an input interface, which may, e.g., be implemented a demultiplexer 902.

The audio decoder 900 of FIG. 9 may, e.g., comprise a transport channel decoder 910, which may, e.g., be configured to reconstruct, during an active phase/mode, the transport/downmix channels from the bitstream during the active phase.

Furthermore, the audio decoder 900 may, e.g., comprise a noise information determiner, e.g., being implemented as an SID decoder (silence insertion descriptor decoder) 920, which may, e.g., be configured to decode a silence insertion descriptor frame of a mono signal.

Moreover, the audio decoder 900 may, e.g., comprise a multi-channel generator 930, e.g., being implemented as a mono to stereo converter 930, which may, e.g., be configured to generate, during an inactive phase/mode, at least two (downmix) channels from the SID information of a mono signal and from a control parameter.

Furthermore, the audio decoder 900 of FIG. 9 may, e.g., comprise a filterbank analysis module 940.

Moreover, the audio decoder 900 may, e.g., comprise a (e.g., spatial) renderer 950, which may, e.g., be configured to reconstruct, during the active phase/mode, a spatial output signal from the decoded transport/downmix channels and, e.g., from the transmitted active metadata and, e.g., from the reconstructed background noise in the transport/downmix channels and, e.g., from transmitted inactive metadata during the inactive phase.

The audio decoder 900 of FIG. 9 may, e.g., comprise a synthesis module for conducting a (e.g., frequency band) synthesis on the spatial output signal of the renderer 950.

The audio decoder 900 of FIG. 9 may, e.g., further comprise a voice activity information determiner 905 for determining, for example, depending on the VAD data in the bitstream, that the decoder shall operate in either active or inactive form (either in an active mode or in an inactive mode).

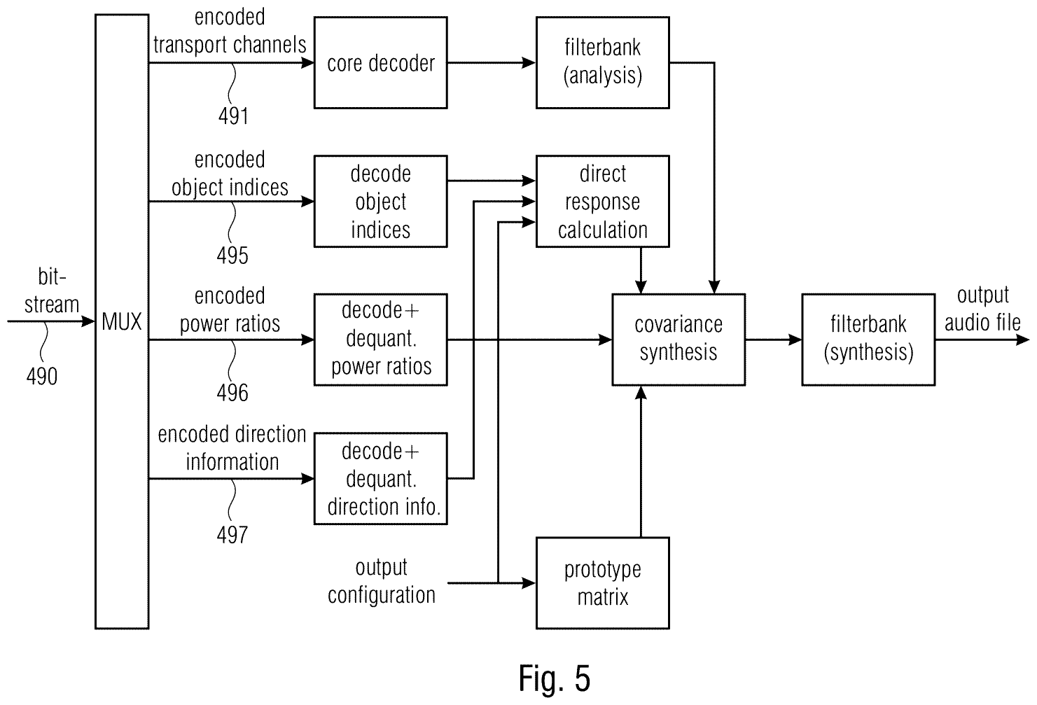

In the active mode (in the active form), which is now described, the decoder described in FIG. 9 is more efficient compared to the decoder described in FIG. 5.

FIG. 10 illustrates spatial renderer, e.g., for covariance rendering, according to an embodiment. The renderer 950 illustrated in FIG. 9 may, e.g., be implemented as the spatial renderer of FIG. 10.

The renderer may, e.g., comprise a signal power computation unit 951 for computing a reference power depending on the transport/downmix channels per time/frequency tile.

Moreover, the renderer may, e.g., comprise a direct power computation unit 952 for scaling the reference power using transmitted power ratios in the active phase, and using, e.g., either a constant scaling factor, which depends on transmitted number of objects, or, e.g., a scaling factor transmitted as part of metadata or, e.g., no scaling in the inactive phase.

Furthermore, the renderer may, e.g., comprise direct response computation unit 953 for computing a direct response depending on quantized direction information of dominant objects during the active phase or depending on quantized direction information of all transmitted objects during the inactive phase.

Moreover, the renderer may, e.g., comprise an input covariance matrix computation unit 954 for computing the input covariance matrix based on the transport/downmix channels.

Furthermore, the renderer may, e.g., comprise a target covariance matrix computation unit 955 for computing a target covariance matrix depending on the output of the direct power computation block 952 and depending on the output of the direct response computation block 953 (or depending on a computed covariance matrix that depends on the output of the direct response computation block 953).

Moreover, the renderer may, e.g., comprise a mixing matrix computation unit 956 for computing the mixing matrix for rendering depending on the input covariance matrix and depending on the target covariance matrix.

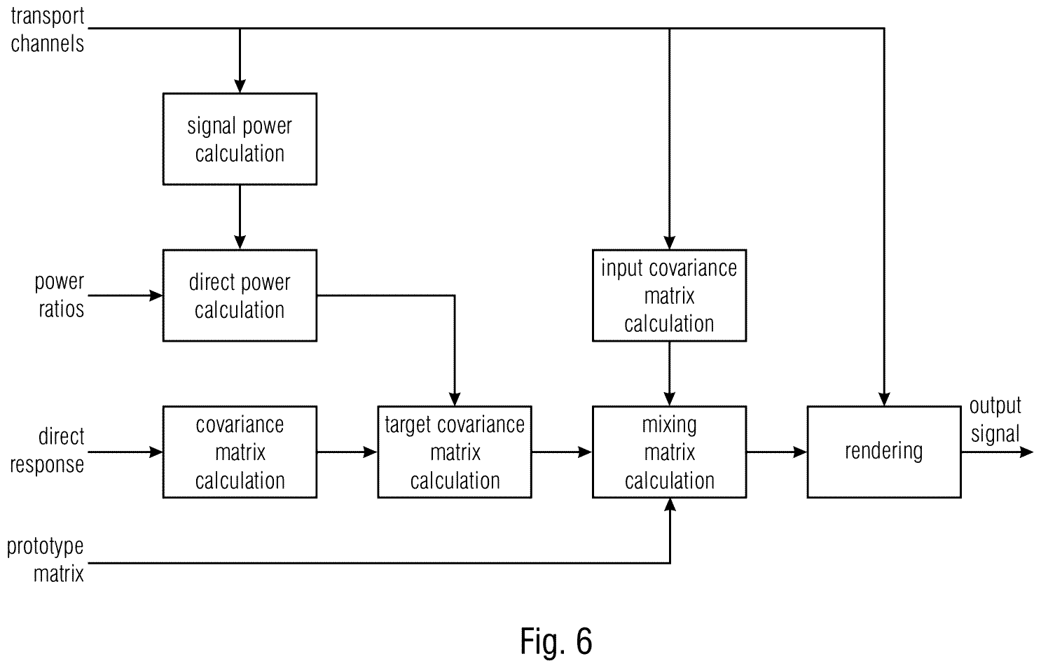

For example, for the mixing matrix, the covariance synthesis may employ the prototype matrix, the input covariance matrix Cₓ=xx^{T} and the target covariance matrix Cy. As described with reference to FIG. 6.

Furthermore, the renderer may, e.g., comprise an amplitude panning unit 957 for conducting amplitude panning on the transport channels depending on the mixing matrix calculated by the mixing matrix computation unit 956

The spatial renderer for covariance synthesis based rendering depicted in FIG. 10 may, e.g., employ the active metadata, e.g., the quantized direction information, object indices and power ratios. The covariance rendering is thus more efficient compared to the covariance rendering shown in FIG. 3.

The transport channel decoder 910 of FIG. 9 may, e.g., decode the two channels of the stereo downmix in the bitstream independently. The stereo downmix may, e.g., then be fed into a filterbank analysis module 940 before providing it as input to the covariance synthesis.

In the inactive mode (in the inactive mode), which is now described, an SID decoder 920 and a mono to stereo converter 930 may, e.g., employ the encoded SID information of the mono channel to generate a stereo signal with some spatial decorrelation.

According to an embodiment, an efficient implementation of the mono to stereo conversion may, e.g., be employed, which may, e.g., run a random generator twice with different seed. In an embodiment, the generated noise may, e.g., be shaped with the SID information of the mono channel. By this, a stereo signal (with zero coherence) is generated.

In another embodiment, the mono channel may, e.g., be copied to both stereo channels (which has, however, the disadvantage to create a spatial collapse and a coherence of one).

In an embodiment, to generate the stereo signal (\tilde{X}_{L}, \tilde{X}_{R}) with a coherence and energy similar to an input stereo downmix, control parameters such as coherence and/or correlation and a scaling factor may, e.g., be employed that may, e.g., be transmitted as part of inactive metadata.

$${\tilde{X}}_{L} ( k , n ) = {s}_{L} ( n ) * [ \sqrt{1 - c ( n )} * {N}_{1} ( k , n ) + \sqrt{c ( n )} * {N}_{3} ( k , n ) ]$$

$${\tilde{X}}_{R} ( k , n ) = {s}_{R} ( n ) * [ \sqrt{1 - c ( n )} * {N}_{2} ( k , n ) + \sqrt{c ( n )} * {N}_{3} ( k , n ) ]$$

$$where {s}_{L} ( n ) = s$$

$${s}_{R} ( n ) = 1 - s$$

where k is the frequency index, n is the sample index, c(n) is either the coherence or correlation transmitted as part of inactive metadata, s_{L}(n) and s_{R}(n) are the scaling factors derived from the scaling factor s transmitted as part of inactive metadata, N₁(k, n), N₂(k, n) and N₃(k, n) are random noises generated by different random generators with seed1, seed2 and seed3 respectively.

Since the inactive metadata does not comprise power ratios and object indices, during the direct power computation, a scaling factor that may, e.g., be dependent on the number of objects may, e.g., be employed instead of the power ratios. Or, a scaling factor that is either transmitted as part of inactive metadata may, e.g., be employed, e.g., instead of the power ratios.

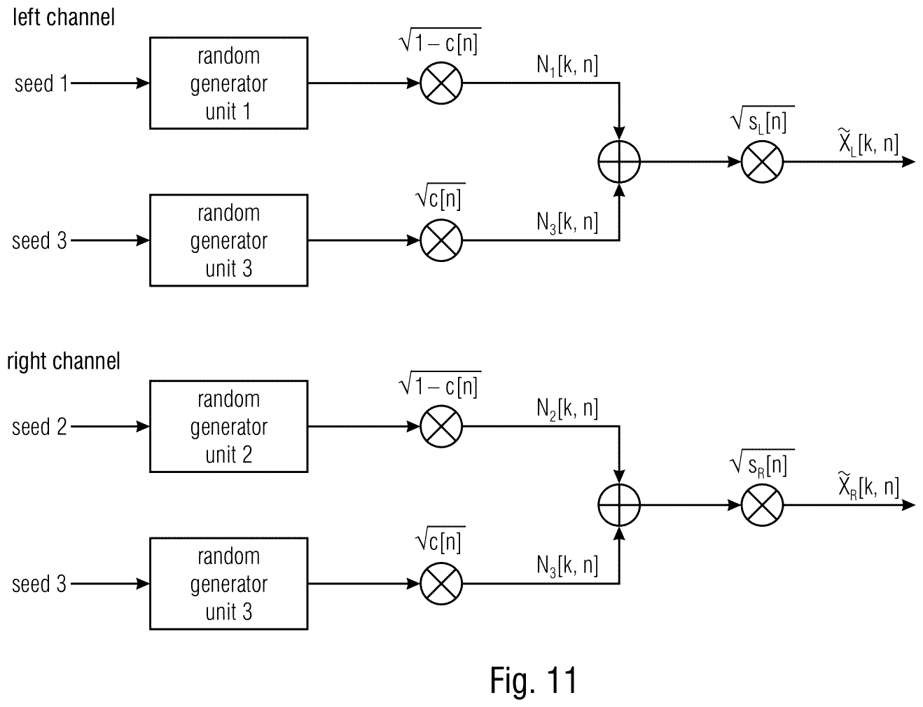

FIG. 11 illustrates the generation of a stereo signal according to an embodiment, using three random seeds seed1, seed2 and seed3, derived scaling factors, and control parameters.

Moreover, FIG. 11 illustrates a random generator comprising a Random Generator unit 1 and a Random Generator unit 3 for generating the left channel, and a Random Generator unit 2 and another Random Generator unit 3 for generating the right channel.

In FIG. 11, the Random Generator unit 3 for generating the left channel and Random Generator unit 3 for generating the right channel receive the same seed, seed 3, and therefore may, e.g., generate a same random noise N₃(k, n).

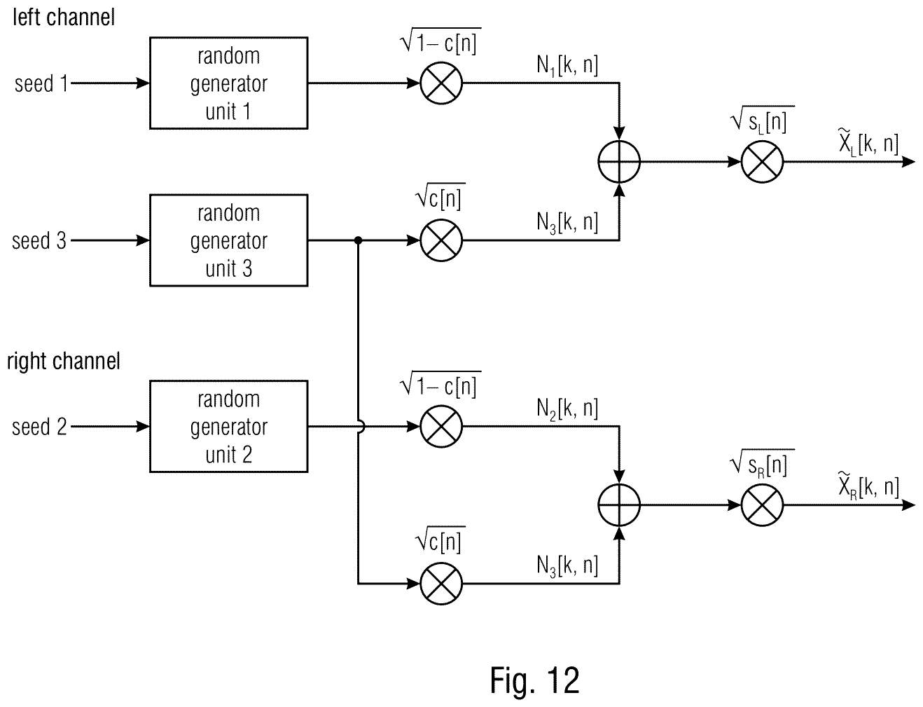

FIG. 12 illustrates the generation of a stereo signal according to another embodiment, wherein the generated noise N₃(k, n) of Random Generator unit 3 for the left channel is also used for the right channel. In other words, the random generator of FIG. 12 comprises a Random Generator unit 1, a Random Generator unit 2 and only a single Random Generator unit 3.

In a further embodiment, the random generator may, e.g., only comprise a single random generator unit, which may, e.g., be employed to sequentially generate the random noises N₁(k, n), N₂(k,n) and N₃(k, n) in response to receiving seed 1, seed 2 and see3, respectively.

In other embodiments, the above concept is analogously applied to generating multi-channel signals with more than two channels.

In addition, a direct response may, e.g., be computed using direction information of all the objects instead of only the dominant objects.

Embodiments allow extending DTX to spatial audio coding with independent streams with metadata (ISM) in an efficient way. The spatial audio coding maintains a high perceptual fidelity regarding the background noise even for inactive frames for which the transmission may, e.g., be interrupted for communication bandwidth saving.

The decoder-side transport channels having a number of channels being greater than one may, e.g., generated just from a transmitted mono signal by the comfort noise generator (CNG), such that they exhibit a spatial image from the SID information. The generated transport channels may, e.g., then be fed into a covariance synthesis module along with a direct response computed from the direction information of all audio objects, equal power ratios and a prototype matrix to for being rendered into a needed output layout.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] WO 2022/079049 A2, A. “Apparatus and method for encoding a plurality of audio objects and apparatus and method for decoding using two or more relevant audio objects”.
[2] WO 2022/079044 A1 “Apparatus and method for encoding a plurality of audio objects using direction information during a downmixing or apparatus and method for decoding using an optimized covariance synthesis”.
[3] 3GPP TS 26.194; Voice Activity Detector (VAD);—3GPP technical specification Retrieved on 2009 Jun. 17.
[4] 3GPP TS 26.449, “Codec for Enhanced Voice Services (EVS); Comfort Noise Generation (CNG) Aspects”.
[5] 3GPP TS 26.450, “Codec for Enhanced Voice Services (EVS); Discontinuous Transmission (DTX)”.
[6] A. Lombard, S. Wilde, E. Ravelli, S. Döhla, G. Fuchs and M. Dietz, “Frequency-domain Comfort Noise Generation for Discontinuous Transmission in EVS,” 2015 IEEE International Conference on Acoustics, Speech and Signal Processing (ICASSP), Brisbane, Q L D, 2015, pp. 5893-5897, doi: 10.1109/ICASSP.2015.7179102.
[7] WO 2022/022876 A1 “Apparatus, method and computer program for encoding an audio signal or for decoding an encoded audio scene”.

1. An audio encoder, comprising:
a transport signal generator for generating two or more transport channels of a transport signal from audio input comprising at least one of a plurality of audio input objects and a plurality of audio input channels,
a voice activity determiner for determining a voice activity decision for the transport signal, which indicates whether or not the audio input within the transport signal exhibits voice activity, and
a bitstream generator for generating a bitstream depending on the audio input,
wherein, if the voice activity determiner has determined that the transport signal exhibits voice activity, the bitstream generator is adapted to encode the two or more transport channels within the bitstream,
wherein, if the voice activity determiner has determined that the transport signal does not exhibit voice activity, the bitstream generator is suitable to encode, instead of the two or more transport channels, information on a background noise, wherein the information on the background noise comprises information on a background noise of at least one of the two or more transport channels or information on a background noise of a derived signal which depends on at least one of the two or more transport channels.

2. An audio encoder according to claim 1,
wherein the voice activity determiner is configured to determine an individual voice activity decision for each transport channel of one or more transport channels of the transport signal, which indicates whether or not the audio input within the transport channel exhibits voice activity, and
wherein the voice activity determiner is configured to determine the voice activity decision for the transport signal depending on the individual voice activity decision of each transport channel of the one or more transport channels.

3. An audio encoder according to claim 2,
wherein the voice activity determiner is configured to determine an individual voice activity decision for each transport channel of the two or more transport channels of the transport signal, which indicates whether or not the audio input within said transport channel exhibits voice activity, and
wherein the voice activity determiner is configured to determine the voice activity decision for the transport signal depending on the individual voice activity decision of each transport channel of the two or more one transport channels of the transport signal.

4. An audio encoder according to claim 3,
wherein the voice activity determiner is configured to determine that the transport signal exhibits voice activity, if at least one of the two or more transport channels of the transport signal exhibits voice activity, and
wherein the voice activity determiner is configured to determine that the transport signal does not exhibit voice activity, if none of the two or more transport channels of the transport signal exhibits voice activity.

5. An audio encoder according to claim 1,
wherein the audio encoder is configured to determine, if the voice activity determiner has determined that the transport signal does not exhibit voice activity, whether to transmit the bitstream having encoded therein the information on the background noise, or whether to not generate and to not transmit the bitstream.

6. An audio encoder according to claim 1,
wherein the audio encoder comprises a mono signal generator for generating, if the voice activity determiner has determined that the transport signal does not exhibit voice activity, the derived signal as a mono signal from at least one of the two or more transport channels, and
wherein the audio encoder comprises an information generator for generating the information on the background noise as information on the background noise of the mono signal.

7. An audio encoder according to claim 6,
wherein the mono signal generator is configured to generate the mono signal by adding the two or more transport channels or by adding two or more channels derived from the two or more transport channels, or
wherein the mono signal generator is configured to generate the mono signal by choosing that transport channel of the two or more transport channels which exhibits a higher energy.

8. An audio encoder according to claim 6,
wherein the information generator is configured to generate the information on a background noise of the mono signal as the information on the mono signal.

9. An audio encoder according to claim 8,
wherein the information generator is configured to generate a silence insertion description of the background noise of the mono signal as the information on the background noise of the mono signal.

10. An audio encoder according to claim 1,
wherein the audio encoder comprises a direction information determiner for determining direction information depending on the audio input,
wherein the audio encoder comprises a direction information quantizer for quantizing the direction information to acquire quantized direction information, and
wherein the bitstream generator is configured to encode the quantized direction information within the bitstream.

11. An audio encoder according to claim 10,
wherein the transport signal generator is configured to generate the two or more transport channels of the transport signal from the audio input using the direction information.

12. An audio encoder according to claim 10,
wherein the audio input comprises the plurality of audio input objects,
wherein the direction information comprises information on an azimuth angle and on an elevation angle of an audio input object of the plurality of audio input objects of the audio input.

13. An audio encoder according to claim 1,
wherein the audio encoder comprises an active metadata generator for generating metadata comprising at least one of quantized direction information, object indices and power ratios of the plurality of audio input objects and or of the plurality of audio input channels of the audio input, if the voice activity determiner has determined that the transport signal exhibits voice activity.

14. An audio encoder according to claim 1,
wherein the audio input comprises the plurality of audio input objects, and
wherein the audio encoder comprises an inactive metadata generator for generating, if the voice activity determiner has determined that the transport signal does not exhibit voice activity, metadata comprising quantized direction information and control parameters, for example comprising a scaling factor and/or either a coherence or a correlation.

15. An audio encoder according to claim 13,
wherein the direction information that is generated by the inactive metadata generator differs in a quantization resolution from the metadata that is generated by the active metadata generator.

16. An audio encoder according to claim 13,
wherein the audio input comprises the plurality of audio input objects, and
wherein the audio encoder comprises an inactive metadata generator for generating, if the voice activity determiner has determined that the transport signal does not exhibit voice activity, metadata comprising quantized direction information and control parameters, for example comprising a scaling factor and/or either a coherence or a correlation,
wherein the inactive metadata generator is configured to generate the control parameters such that the control parameters differ in characteristics from a characteristics of power ratios and object indices that are generated by the active metadata generator, for example wherein the control parameters comprise, e.g., the scaling factor and/or, e.g., either the coherence or the correlation.

17. An audio encoder according to claim 1,
wherein the audio input comprises a plurality of audio input objects and metadata being associated with the audio input objects.

18. An audio encoder according to claim 1,
wherein the transport signal generator is configured to generate the two or more transport channels of the transport signal from the audio input comprising by downmixing at least one of a plurality of audio input objects and a plurality of audio input channels to acquire a downmix as the transport signal, which comprises two or more downmix channels as the two or more transport channels.

19. An audio encoder according to claim 10,
wherein the transport signal generator is configured to generate the two or more transport channels of the transport signal from the audio input comprising by downmixing at least one of a plurality of audio input objects and a plurality of audio input channels to acquire a downmix as the transport signal, which comprises two or more downmix channels as the two or more transport channels,
wherein, if the audio input within the transport signal does not exhibit voice activity, the direction information quantizer is configured to determine the quantized direction information such that a quantization resolution of the quantized direction information is different from a quantization resolution used for computing the downmix.

20. An audio encoder according to claim 14,
wherein the bitstream generator is configured to encode the control parameters within the bitstream, if the voice activity determiner has determined that the transport signal does not exhibit voice activity,
wherein the control parameters are suitable for steering a generation of an intermediate signal from random noise,
wherein the control parameters either comprises a plurality of parameter values for a plurality of subbands, or wherein the control parameters are single broadband control parameters.

21. An audio encoder according to claim 20,
wherein the audio encoder is configured generate the control parameters, by selecting, whether the control parameters either comprises the plurality of parameter values for the plurality of subbands, or whether the control parameters are the single broadband control parameters, depending on an available bitrate.

22. An audio encoder according to claim 1,
wherein the transport signal generator is configured to encode the audio input by applying Code-Excited Linear Prediction or by applying a Modified Discrete Cosine Transform or by applying a combination of the Code-Excited Linear Prediction and of the Modified Discrete Cosine Transform.

23. An audio encoder according to claim 1,
wherein, if the audio input comprises the plurality of audio input channels, but not the plurality of audio input objects, a number of the two or more transport channels is smaller than a number of the plurality of audio input channels,
wherein, if the audio input comprises the plurality of audio input objects, but not the plurality of audio input channels, the number of the two or more transport channels is smaller than a number of the plurality of audio input objects,
wherein, if the audio input comprises both the plurality of audio input objects and the plurality of audio input channels, the number of the two or more transport channels is smaller than a sum of the number of the plurality of audio input channels and the number of the plurality of the audio input objects;
or
wherein, if the audio input comprises the plurality of audio input channels, but not the plurality of audio input objects, a number of the two or more transport channels is smaller than or equal to a number of the plurality of audio input channels,
wherein, if the audio input comprises the plurality of audio input objects, but not the plurality of audio input channels, the number of the two or more transport channels is smaller than or equal to a number of the plurality of audio input objects,
wherein, if the audio input comprises both the plurality of audio input objects and the plurality of audio input channels, the number of the two or more transport channels is smaller than or equal to a sum of the number of the plurality of audio input channels and the number of the plurality of the audio input objects.

24. A system, comprising:
an audio encoder according to claim 1, and
an audio decoder,
wherein the audio decoder comprises:
an input interface for receiving a bitstream which depends on audio content comprising at least one of a plurality of audio objects and a plurality of audio channels; wherein a transport signal comprising two or more transport channels is encoded within the bitstream, and the audio content is encoded within the transport signal; or wherein information on a background noise is encoded within the bitstream instead of the transport signal, wherein the information on the background noise comprises information on a background noise of at least one of the two or more transport channels or information on a background noise of a derived signal which depends on at least one of the two or more transport channels; and
a renderer for generating one or more audio output signals depending on the audio content being encoded with the bitstream;
wherein, if the transport signal comprising the two or more transport channels is encoded within the bitstream, the renderer is configured to generate the one or more audio output signals depending on the two or more transport channels, and
wherein, if the information on the background noise is encoded within the bitstream instead of the transport signal, the renderer is configured to generate the one or more audio output signals depending on the information on the background noise,
wherein the audio encoder is configured to generate a bitstream from audio input, and
wherein the audio decoder is configured to generate one or more audio output signals from the bitstream.

25. A method for audio encoding, wherein the method comprises:
generating two or more transport channels of a transport signal from audio input comprising at least one of a plurality of audio input objects and a plurality of audio input channels,
determining a voice activity decision for the transport signal, which indicates whether or not the audio input within the transport signal exhibits voice activity, and
determining a bitstream depending on the audio input,
wherein, if it has been determined that the transport signal exhibits voice activity, the method comprises encoding the two or more transport channels within the bitstream,
wherein, if it has been determined that the transport signal does not exhibit voice activity, the method comprises encoding, instead of the two or more transport channels, information on a background noise of at least one of the two or more transport channels or information on a background noise of a derived signal which depends on at least one of the two or more transport channels.

26. A non-transitory digital storage medium having a computer program stored thereon to perform the method for audio encoding, wherein the method comprises:
generating two or more transport channels of a transport signal from audio input comprising at least one of a plurality of audio input objects and a plurality of audio input channels,
determining a voice activity decision for the transport signal, which indicates whether or not the audio input within the transport signal exhibits voice activity, and
determining a bitstream depending on the audio input,
wherein, if it has been determined that the transport signal exhibits voice activity, the method comprises encoding the two or more transport channels within the bitstream,
wherein, if it has been determined that the transport signal does not exhibit voice activity, the method comprises encoding, instead of the two or more transport channels, information on a background noise of at least one of the two or more transport channels or information on a background noise of a derived signal which depends on at least one of the two or more transport channels,
when said computer program is run by a computer.
